(19) United States
(12) Patent Application Publication
(10) Pub. No.: US 2007/0134644 A1
(43) Pub. Date: Jun. 14, 2007

(54) 3D learning environment

(76) Inventors: James G. Jones, Denton, TX (US); William R. Reed, Dallas, TX (US)

Correspondence Address: LAW OFFICE OF STEVEN B. LEAVITT, L.L.P., P.O. BOX 537, ROWLETT, TX, 75030-0537, US

(21) Appl. No.: 11/298,091

(22) Filed: Dec. 11, 2005

(51) Int. Cl. G09B 25/00

(52) U.S. Cl. 434/365

(57) ABSTRACT

The present invention provides a learning environment that presents information in an organized fashion with defined objectives using an extension of current 3D online technology. By combining 3D virtual space technology with additional asynchronous and synchronous communications features, a content rich learning environment can be created that allows students more realistic interactions than those provided by currently deployed systems. In addition, the system allows for the overlay and integration of 2D, text-based, and audio-based learning tools both within and outside the 3D environment and provides an interface with convergence technology such as cell phones, pagers, hand held computers, etc as well as collaborative tools such as presentation of overheads, computer software slide presentations such as MICROSOFT POWERPOINT, whiteboard, virtual network computing (VNC), and for class lectures, whiteboard, virtual network computing (VNC), and other collaborative tools layered into the 3D environment.

### BACKGROUND OF THE INVENTION

1. Technical Field

The present invention relates to the field of learning environments, and more particularly to online distance learning environments.

2. Description of Related Art

In a learning environment, typically the goal is to teach or educate a student by presenting information in an organized fashion with defined objectives. These objectives are usually predefined lessons or messages an educator wants to communicate to the student. For purposes of this application, a student is anybody being educated and is not limited to those enrolled in a formal educational system such as a public school or university.

Often, students seeking education must travel to a physical learning environment such as a classroom or meeting room type setting. There, the presentation of a lesson or message is done in real time by the instructor through a lecture, slide show, use of a blackboard or dry erase board, or some other type of presentation in the classroom. Also, the instructor may take the students on a “field trip” where participants travel to a museum, art gallery, natural wonder, or some other place of interest.

The problem with such a learning environment is that those desiring the education must physically travel to the destination to receive the lesson or message. This prevents students who cannot efficiently travel outside their local area from participating. The advantage of the Internet is that those desiring the education do not have to physically travel to a destination to receive the lesson or message.

Most Internet, or distance learning, applications rely on posted text or graphics that one views to receive the lesson or message. Examples include WEBCT CAMPUS EDITION application from WebCT, Inc. located in Lynnfield, Mass., BLACKBOARD ACADEMIC SUITE by Blackboard Inc. located in Washington, D.C., and FIRSTCLASS ED software by the Open Text Corporation located in Ontario, Canada

WEBCT CAMPUS EDITION allows instructors to design materials to be loaded into a system that is then accessed and read by students. The system provides instructor with the ability to create personalized learning paths to ensure mastery of one concept before the next one is presented. However, the system is mostly text based.

The FIRSTCLASS ED software is also text based but has the added feature of utilizing unified communications tools to allow online student collaborative conferences, student-to-student tutoring services, and private teacher-to-student assistance. Further the FIRSTCLASS ED software combines a user's email, voice, and fax messages into a mailbox. The system allow users access to all of their messages via the device of their choice including cell phone, telephone, personal computer, web browser or personal digital assistant. Some software takes advantage of telephone conferencing and file sharing technology to create online meeting systems such as those offered by WEBEX by WebEx Communications, Inc. located in Santa Clara, Calif. and Microsoft's NETMEETING, by Microsoft Corporation located in Redmond, Wash. However, these applications do not include a dynamic 3D (three dimensional) learning environment.

One application, ACTIVE WORLDS EDUCATIONAL UNIVERSE (AWEDU) by Activeworlds Inc. located in Newburyport, Massachusetts, is a simulated 3D environment. The system is a client-based interactive content interface, which is devoted solely to education initiatives. Users can define and customize their world whichever way they choose by selecting objects from the AWEDU object library or by adding custom built objects. The AWEDU browser interface is comprised of four main scalable windows that include a simulated 3D environment, a chat dialogue window, an integrated web browser, and a window for added navigational and communicational functions. The simulated 3D environment is one of the settings for interaction wherein users represented as avatars move and interact with each other and the environment. Directly beneath the simulated 3D environment is a chat window. Communication is limited to text messages that display above both the speaker's avatar in the simulated 3D environment and in the chat window below.

Some of the drawbacks of AUWDU are that it does not provide unified communications or collaborative tools in the 3D environment and does not support integrated audio. The learning environment is a rough 3D world in one single window that then displays web-like information in secondary windows surrounding the 3D window similar to frames. This creates an unnatural and sometimes confusing 3D environment. In addition, interaction between users in the 3D environment is based solely on distance from the user. Thus two people can be standing in two different rooms such that they do not see each other and still be able to read each others text and see what the other is doing. This further detracts from the 3D environment and can interfere with the learning process. In addition, AUWDU cannot be run from a standalone computer.

Collaborative groupware or unified communications systems such as those listed above provide the tools needed for communications in a text based distance learning course, but they do so without creating a content rich learning environment using 3D gaming engines like the HAVOC engine created by the Havoc Company located in San Francisco, Calif.

What is needed is system that provides a dynamic 3D learning environment wherein information is presented in an organized manner with defined objectives. The system should combine 3D online virtual spaces like those used in a massively multiplayer online role playing game with persistence and unified communications that integrate audio and text both to groups and individuals.

The system should allow for the overlay and integration of dynamic 2D (two dimensional), text-based, and audio-based learning tools both within and on top of the 3D environment. It would be beneficial if the system could provide an interface with convergence technology such as cell phones, pagers, hand held computers, and other convergence technology as well as collaborative tools such as presentation of overheads, PowerPoint presentations, whiteboard, virtual network computing (VNC), and other collaborative tools layered into the 3D environment, as well as additional features such as student contributed content, permission groups, portal based communications, persistence between sessions, server cluster configurations to allow expansion from one student to thousands or more students, recording of 3D environments and communications for later playback, combination of client-server and peer-to-peer audio transmission.

It would be further beneficial if a student could access a server cluster via a 3D online graphical client that creates the environment on a local computing device. The server cluster should allow multiple students to interact in environments that could be used for education, professional development, and e-commerce as well as for asynchronous and synchronous distributed learning such as synchronous lectures for courses, asynchronous recording of a course for later playback, and creation of simulations that one or more users could interact with to accomplish training such as situated learning.

The system should work well over low speed connection such as dialup as well as high speed connection such as broadband, create an easier and more intuitive interface than existing web-based approaches, not require top of the line graphics cards, be better at creating virtual learning communities than text-based approaches, provide a single interface for multi-modal communication interfaces, scale better than videoconference technology, and provide gender equity capacities in countries that have issues with genders by allowing women to choose male looking avatars.

In addition, it would be beneficial if the system would break up communications based on logical spaces, such rooms instead of distance to that allow two people in different rooms that could not see each other to communications through general communications.

### SUMMARY OF THE INVENTION

The present invention provides a learning environment that presents information in an organized fashion with defined objectives using an extension of current 3D online technology. The system combines 3D online virtual spaces like those used in persistent online games with unified communications that integrate audio and text both to groups and individuals. Aspects of collaborative groupware and unified communications tools and the current state of the art in real-time interaction software are integrated into the 3D learning environment. By combining 3D virtual space technology with additional asynchronous and synchronous communications features, a content rich learning environment can be created that allows students more realistic interactions than those provided by currently deployed systems.

In addition, by integrating aspects of collaborative groupware and unified communications tools into the 3D environment, the system allows for the overlay and integration of 2D graphics, text-based, and audio-based learning tools both within and outside the 3D environment and provides an interface with convergence technology such as cell phones, pagers, hand held computers, etc as well as collaborative tools such as presentation of overheads, computer software slide presentations such as MICROSOFT POWERPOINT, whiteboard, virtual network computing (VNC), and other collaborative tools layered into the 3D environment, as well as additional features such as student contributed content, permission groups, portal based communications, persistence between sessions, server cluster configurations to allow expansion from one student to thousands or more of students, recording of 3D environments and communications for later playback, combination of client-server and peer-to-peer audio transmission.

In use, a local computer with 3D video graphics technology is used to access an online server cluster that creates the interactive learning environment on the local computer. The server cluster allows multiple students to interact in the learning environment, provides a single interface for multi-modal communication interfaces, scales and distributes more efficiently than current video conference technology, and provides gender equity capacities in countries that have issues with genders by allowing women to choose male looking avatars. Text, graphics, and other multimedia elements are presented to the user either on-top of or placed within the 3D generated environment being displayed on the computing device. The system also allows for recording a course or simulation for later playback. Once the local computer has access to the server cluster, the objects the user will interact with are downloaded to the local computer from the server cluster. Then the user can terminate access with the server cluster or for synchronous interactive sessions with other users, remain connected wherein some information may be stored on the server cluster. In an alternate embodiment, the objects the user will interact with or other information is not downloaded from a server but is contained in an electronic storage device such as a CD, DVD, flash drive, or some other similar electronic storage media.

The programming for the system of the present invention is written in Java and uses the OpenGL API to communicate to the graphics card on the local computer. The libraries used are know in the art and are standard programming tools. Examples include Xith, an open source 3D scenegraph for Java that is available via the Internet and Crystal Space, or any other similar type open source 3D software development kit (SDK) available via the Internet. The software contained on the local computer consists of the following modules/segments: the VXI client is the first module that is run and its task is to launch the controller; the controller handles the active processes or modules and launches the communication, message management system, screen, user I/O and any other modules running as threads. It also launches the controls for level logging and error modules for handling errors. The communication or networking module handles the communications between the client and server. The message management module handles the logic of message packets between client and server and talks to the communication or networking module. The screen module handles the display of all graphics on the client screen. This includes talking to the OpenGL API. The GUI, 3D world, Models, and others are rendered by this module. The user I/O module handles the mouse, keyboard, and other user input/output devices.

The 3D online environment is created by software on a local computer and the local computer may not be connected to the server cluster. Connection to the server cluster allows for synchronous interaction with other users. The system works well over low speed connections such as dialup as well as high speed connections such as broadband because the 3D rendered environment is rendered and not constantly retransmitted. Also, only visible areas that the user can see are displayed not everything in front of the view of the user in the 3D environment—which could include rooms behind other rooms that might not be in the direct line of sight. This reduces the amount of drawing and limits the number of updates, thus allowing us to support more users in an environment when the users are spread out in that environment. The initial bandwidth is minimal and can easily support those without access to a relatively fast Internet connection such as users on dialup connection. In addition, the cluster server and the fact that the 3D environment is rendered faster, allows for growth to accommodate higher-bandwidth and more multi-media objects as faster access to the Internet becomes available.

The present invention can be also be used to increase instructor contact hours for at-risk students and to build online communities of learners in order to increase student satisfaction and increase retention rates. If an at-risk-student (a student who is at risk of not passing) is able to have the control to create and interact in their own learning environment on his schedule, then the at-risk-student is more likely to interact with the learning environment and achieve the defined learning objective.

The present invention allows for the presentation and user interaction with “copies” of real-life objects such as museum or scientific objects in the 3D online learning environment. These items may not be available for access without physically visiting the museum or science lab. Also, the objects may have restricted access due to age or security concerns. The objects might be dangerous or of such a nature that untrained or unsupervised access to the object is prohibited. By providing “copies” of real-life objects in a 3D learning environment, the student can be immersed in the instructional environment. This creates a content rich learning environment that can be access from virtually anywhere in the world at any time.

While the invention has been particularly shown and described with reference to a preferred embodiment, it will be understood by those skilled in the art that various changes in form and detail may be made therein without departing from the spirit and scope of the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a block diagram depicting the systems operational steps for presenting the content rich learning environment of the present invention; and

FIG. 2 is a block diagram depicting the architecture of the present invention.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

FIG. 2 illustrates server cluster 202, servers 204, and local computer 206. Server cluster 202 is a typical server cluster known in the art wherein a group of servers on different physical servers 204 each have the same applications configured within them, but all servers 204 operate as a single logical server in the server cluster 202. Server cluster 202 is connected to at least one local computer 206 via network link 208. Network link 208 may be the Internet, WAN, LAN, or some other similar type of connection used to connect a local computer to a server cluster and may use a communications protocol stack that includes transmission control protocol (TCP) and Internet protocol (IP) layers, sequenced packet exchange (SPX) and internetwork packet exchange (IPX) layers, Appletalk transaction protocol (ATP) and datagram delivery protocol (DDP) layers, DOCSIS, or any other suitable protocol or combination of protocols. Local computer 206 may be any type of computer system that is capable of running the present invention. Local computer 206 may also be a stand alone computer wherein the data necessary for the present invention is contained on a storage device. The storage device may be any suitable storage device, such as a hard disk, floppy disk drive, flash RAM card, recordable CD-ROM drive, DVD-ROM, or any other suitable storage device known in the art.

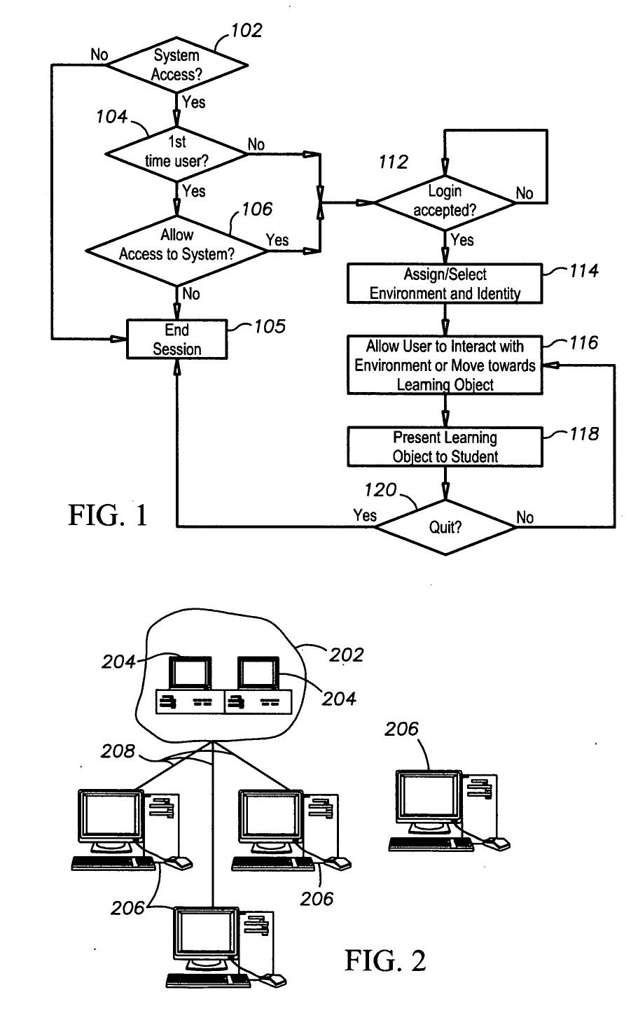

FIG. 1 depicts the steps the system uses to provide a learning environment that presents information in an organized fashion with defined objectives. First, the system is accessed or loaded, Step 102. System access may by acquired through a hyperlink, a keyword, number, alphanumeric login, finger print scan, retinal scan, facial recognition, or any other typical method for accessing a system known in the art. If system access cannot be obtained, then the session ends, Step 105. If access to they system has been obtained, the system determines if the user is a first time user, Step 104. This may be done by providing the user a “first time user” option to select or comparing the keyword, number, alphanumeric login, finger print scan, retinal scan, facial recognition, or other similar data to the data stored in the system's login database. If the information is in the system's login database, then the system may log the user into the system, Step 112. If the “first time user” option is selected or the keyword, number, alphanumeric login, finger print scan, retinal scan, facial recognition, or other similar data is not in the system's login database, then the system determines the user is a first time user. Next, the system determines if the first time user will be allowed to access the system either through pre-defined rules or through an administrator that gives authorization to the user for access to the system, Step 106. An administrator can be any user with administrative level access to the system. If the user is not allowed to access the system, then the session ends, Step 105. After the new user's login is assigned by the system, the system communicates the login is used to the user and the user uses the login to access the system, Step 112. If the user is not able to login successfully, then the session ends, Step 105.

For users with established login, they may login using a password, finger print scan, retinal scan, facial recognition, or any other typical method for accessing a system known in the art, Step 112. The login may be the same method that was used to access or load the system in Step 102.

After the user logs into the system, the system assigns the user a role based on what level of access the administrator wants the user to have. An example of some roles may be an observer with very limited access to the system, a guest with more access to the system than an observer, a student with more access to the system than a guest, a teacher with more access to the system than a student, or a monitor with more access to the system than a teacher, but not more than an administrator. Within each role there may be different levels. For example, the role of the teacher may include a student teacher with a relatively small amount of access to the system but more than a student role, a regular teacher with a greater amount of access than a student teacher, and a head teacher with a greater amount of access than a regular teacher.

Then, the system creates an identity for the user and assigns a starting location or creates a home environment. The identity can be modified by the administrator or by the user. For example, if the user is a female from a country that does not allow females to obtain an education, the user or the administrator may make the identity of the female appear to be a male. In addition, if the user is from a desert region, the home environment may be a desert that is similar to the user's real home environment. Alternatively, the environment could be a lush mountain country side that would be a complete opposite to the user's real desert environment.

If the user is allowed access to the system, the system displays the user's home environment, Step 114. The display may be a computer monitor or any other similar type of display device known in the art. In one embodiment, the home environment and/or identity can be changed by the user. When changing the home environment or identity, the user may be able to pick from a group of preselected environments or identities or the user may be able to create an environment or identity from scratch. After the system displays the home environment, the system allows the user to interact with the environment and move towards a learning environment, Step 116.

In the learning environment, the system may display instructional items such as bulletin boards, white boards, text boxes, or other means of textual communication; pre-recorded messages or other audio may be played or visual instructional items may be displayed to the user, Step 118. The instructional items may provide the user with information such as a list of learning environments or information necessary for proper use of the system such as rules or a system update that is ready to be downloaded. As shown in Step 120, after the instructional item has been presented to the student, the system allows the student to end the session, Step 105 or continue to interact with the learning environment, Step 116. It should be noted that through the process the system may offer the user several changes to quite or there may be always be an option to quit and end the session.

The system allows the user to move towards a learning environment by responding to keyboard commands, a mouse, joystick commands, or any other typically means a user may move through a system. The learning environment may be incorporated into the home environment or may be a separate area to be moved into.

The learning material may be an audio clip, video, a slide show, image, instant message, bulletin board, white board, text window, user representations of objects such as a planet or other remote object, animated object, or any other learning material that can be represented within the system.

If the learning material is an audio clip, the material may be a live or prerecorded lecture or speech by a teacher or student. The audio could also be to annotate objects such as museum artifacts or paintings, to provide audio clues as to direction or correctness of interaction, or to provide background ambient information to indicate setting or add to the user immersion.

If the learning material is a video, the material may be a live or prerecorded lecture or speech by a teacher or student. The video may be a television recording such as NOVA or the evening news. The video could also be any materials generated and edited with video technology and presented to the user.

If the learning material is a slide show, the slide show could be one of famous statutes, building, or natural wonders. The slide show could also be used to provide information in support of a course lecture or provide standalone materials combined with audio to present a topic or information.

If the learning material is an image, the image could be animals, places, or things. The image could also be any existing, captured, or created image that would enhance the learning experience.

If the learning material is an instant message, the instant message could be from other students helping with a homework assignment or providing notes from a missed class or lecture. The instant message could also be generated by the system to indicate important information or information of interested to the user.

If the learning material is a bulletin board, the bulletin board may contain such information as a link where a new learning environment is located or information needed for the next lecture the user is scheduled to attend. The bulletin board could also be used by students and instructors to share information or provide discussion space in support of learning and instruction.

If the learning material is a white board, the white board may contain such information as a link where a new learning environment is located or information needed for the next lecture the user is scheduled to attend. The white board could also display an existing, captured, or created graphic or other information and allow the participants to interact with the graphic material by adding notes or other important illustrations to enhance the discussion.

If the learning material is a text window, the text window may contain such information as a link where a new learning environment is located or information needed for the next lecture the user is scheduled to attend. The text window could also contain any text-based information that would add to the learning or provide information needed or requested by the user.

If the learning material is other users, the other users may be students, teaching assistants, or teachers helping with a homework assignment or providing notes from a missed class or not fully understood lecture. The other users could also be created artificial intelligences or programmed state machines that could be interacted with to help with learning or providing desired information.

If the learning material is a painting, the painting could be a famous painting that when approached plays an audio message describing the style of the painting or gives a narrative about the painter and the time period he lived. Also, a video may play that shows a picture of the painter and other works the painter may have done.

The learning materials may be representations of objects such as a planet or other remote object. The planet may be mars wherein the details of the plant are provided by NASA. The representations of objects could also be the earth using GIS data or any object where three-dimensional information is available. The user may examine the object or be placed within or on the object, depending on the nature of the data.

If the learning material is an animated object, user can interact of view the object to support learning.

When the system presents learning material to a user, the learning material may be one type or a combination of many types of learning material. The learning material may also be manipulated by the user depending on the level of access the user has. For example if the user has only observer level access, then the user may not be able to interact with the learning material at all. If the user has student level access, the user may be able to interact with the learning material but may not be able to change the learning material. If the user has teacher level access, the user may be able to change or modify or even create learning material.

The user may elect to end the session, Step 105. After the user ends the session, a lesson plan or learned objectives summary may be presented to the user or instructor. Also, the user may “save” or store the place they last visited so if the user can return to complete an unfinished learning objective or be able to repeat a learning environment.

Because a content rich 3D environment is used, the present invention is better at creating virtual learning environments than text-based approaches. For example, in a university type setting, a student would walk through a virtual university and find their class. As the student enters the classroom, they can hear the audio-chat and read the text-chat of the instructor and students interacting. Once in the virtual classroom, the student can find an open seat and sits down or may elect to remain standing. The instructor may display a graphic and lead a discussion relating to the graphic. Then using a marker the instructor may make notes on the overhead concerning what are the more important parts of the materials. Next, the instructor may display a 3D image of a molecule that is being discussed. The student can control and interact with the model as the instructor asks questions or lectures about the molecule.

If the student were late, the student may pop open their virtual digital assistant and access the course conference area and see if there was any information posted before the class started. Then the student may take a second to look around the room to see who showed up for class. For example, the student may notice that most of the classmates are located in the state along with several who are located outside the state and in other countries. After class, the student may drop a message to one of the classmates asking how the weather is in Lisbon, Portugal today and ask about class notes. The classmate may respond and transmit a class notes object over the materials as that classmate saw them. Later in the week while studying for an exam, the student may have a question that they remember being covered in the online lecture. The student can go back into the virtual environment and asks the system to replay the class lecture in question seeing it just as it transpired. Then after reviewing the lecture, the student may still not understand the material so they open their digital assistant and can send a voice mail to the instructor asking for clarification or help. Later the student may get a text-message, instant message, or some other similar message on their cell phone or other communication device informing them that there is a new message available on the campus system. The student may then return to the virtual campus and check his digital assistant. The new message may be a voice message left by the instructor that contains a brief reply to the request for clarification and asks the student to come by for office hours today to discuss the question in more depth.

In a middle school type setting, a student may be working on math and science topics. For one exercise the student may use a 3D environment of the planet Mars in order to focus on a learning objective such as math topics of distance, volume, depth, etc. The student may be assigned problems that require the student to explore the face of Mars in 3D and use various problem-solving skills to work on the desired learning objective. Other students may be working together in the environment to create rovers for exploration on Mars. The rover may be created using tools that are shared among the students. The building of the rover or other similar activity could promote the areas of computer programming, system analysis, structural engineering, collaboration, and other desirable learning objectives.

In a training or professional development setting, city emergency services may prepare for a mass causality simulation. Because the training is in a virtual 3D environment, the various agencies do not need to send representatives to a local park and walk through the training. Instead, the students may access a virtual 3D model of the city showing, from their respective, a courthouse, firehouse, police station, or hospital. An initial session with the facilitator or instructor could begin with specific training and focused activities before the simulation or situated learning begins. Then, the student may move into a simulation that builds upon the instruction to achieve the desired learning objective which in this example is how to deal with a mass causality simulation. As various agencies are dispatched, the simulation may escalate or change to create a training environment as real as possible without the cost associated with real-life training. Another example might be training students on the use of expensive or dangerous equipment. The students could be safely trained to handle such equipment in a virtual environment before training with mentors begins on the actual equipment. After the training or simulation is complete, the students may meet back with the instructor or facilitator to review the session and provide additional instruction and feedback. Where the present invention is not providing the simulation or situated learning, the purpose of the present invention would be to provide the distributed instruction for the external training software.

Although the invention has been described with reference to one or more preferred embodiments, this description is not to be construed in a limiting sense. There is modification of the disclosed embodiments, as well as alternative embodiments of this invention, which will be apparent to persons of ordinary skill in the art, and the invention shall be viewed as limited only by reference to the following claims.

It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

We claim:

1. A method of providing a learning environment by presenting information in an organized fashion with defined objectives, the method comprising the steps of:
creating an interactive 3D learning environment;
transmitting the 3D learning environment to a student; and
communicating with the student using learning objects within the 3D learning environment.

2. The method of claim 1 wherein the communication is synchronous.

3. The method of claim 1 wherein the communication is asynchronous.

4. The method of claim 1 wherein the learning objects are overlaid and integrated 2D learning tools, both within and outside the 3D environment.

5. The method of claim 4 wherein the 2D learning tools are a white board, power point presentation, video, or slide show.

6. The method of claim 1 wherein the learning objects are overlaid and integrated text-based learning tools both within and outside the 3D environment.

7. The method of claim 6 wherein the text-based learning tools are a text window or online bulletin board.

8. The method of claim 1 wherein the learning objects are overlaid and integrated audio-based learning tools both within and outside the 3D environment.

9. The method of claim 8 wherein the audio-based learning tools are a lecture or speech.

10. The method of claim 8 wherein the audio-based learning tools are prerecorded.

11. The method of claim 8 wherein the audio-based learning tools are live.

12. The method of claim 1 wherein the learning objects are other users within the system.

13. The method of claim 1 wherein at least a portion of the data used to create the interactive 3D learning environment is stored on a server.

14. The method of claim 13 wherein the server is part of a server cluster.

15. The method of claim 1 wherein at least a portion of the data used to create the interactive 3D learning environment is stored on a local computer.

16. The method of claim 1 wherein at least a portion of the data used to create the interactive 3D learning environment is stored on a non-volatile storage medium

17. The method of claim 1 wherein the non-volatile storage medium is, at least one of the following: flash media, a CD (compact disk), a DVD, semiconductor memory, a hard disk or combinations thereof.

18. A method of providing a learning environment by presenting information in an organized fashion with defined objectives, the method comprising the steps of:
creating an interactive 3D learning environment;
transmitting the 3D learning environment to a student; and
communicating with the student using learning objects overlaid and integrated within and outside the 3D environment.

19. The method of claim 1 wherein the communication is synchronous.

20. The method of claim 1 wherein the communication is asynchronous.
